(19) United States
(12) Patent Application Publication
(10) Pub. No.: US 2026/0326692 A1
(43) Pub. Date: Oct. 22, 2026

(54) MODULAR AND EXPANDABLE POWER DISTRIBUTION UNIT

(71) Applicant: DUMAREY Automotive Italia S.p.A., Torino (IT)

(72) Inventors: Olivero Cagnazzo, Torino (IT); Gianluca Pedrazzani, Torino (IT); Domenico Rampone, Torino (IT)

(73) Assignee: DUMAREY Automotive Italia S.p.A., Torino (IT)

(21) Appl. No.: 19/114,698

(22) PCT Filed: Sep. 25, 2023
(86) PCT No.: PCT/IB2023/059449

§ 371 Date: Mar. 24, 2025

(30) Foreign Application Priority Data
Sep. 30, 2022 (IT) 102022000020208

(51) Int. Cl. B60R 16/033; H02G 3/08; H02G 3/16; H02G 3/18; H02G 5/06

(52) U.S. Cl. CPC B60R 16/033; H02G 3/083; H02G 3/086; H02G 3/16; H02G 3/18; H02G 5/06

(57) ABSTRACT

A high voltage modular and expandable unit for electrical power distribution for application in the automotive technical sector.

The electrical power distribution unit can use two or more basic electrical modules for any application. The basic electrical module is designed as a high voltage input port connected to an electric/output interface (HV I/O). The basic electrical module may also include current sensors, power relays, fuse and other electrical components that assist the distribution of electrical power.

### RELATED APPLICATIONS

This is a national stage application of PCT application PCT/IB2023/059449 having an international filing date of 25 Sep. 2023. This application claims foreign priority based on application 102022000020208 of Italy, filed on 30 Sep. 2022.

### BACKGROUND OF THE INVENTION

### 1. Field of the Invention

The present invention relates to a modular and expandable unit for electrical power distribution for application in the automotive technical sector and particularly to a modular and expandable unit for electrical power distribution of the type defined in the preamble of claim 1.

### 2. Brief Description of the Prior Art

Electrical power distribution units provide power to various types of electrical users in response to signals received from control units and by exploiting appropriate sources of available electrical power. In the automotive sector and particularly in that of battery and/or fuel cell electric traction (BEV, FCEV the English acronyms) the sources of electric power are precisely batteries, including high voltage ones, and fuel cells. The users of electric power are instead electric motors, electric heaters and other vehicle auxiliaries.

The distribution units must precisely manage the supply of electrical power, supplied as input from different sources, to different users connected to the outputs of the distribution unit itself. For this purpose, the different electrical power inputs are connected to each other and to the different electrical power outputs by means of jumpers made of conductive material (typically copper) which have straight portions and curved portions to be able to appropriately connect the power inputs to the power outputs. In some sectors, for example in the “Information Technology” sector, it has been possible to define modular distribution units serving computer networks. These modular units have multiple outputs and are designed to distribute electrical power to computers and network devices within a designated rack or cabinet.

On the contrary, applications in the automotive sector are highly diversified and this requires the design of very “customized” electrical power distribution units to the detriment of scale economies. There is therefore a notable need for standardization in the sector.

Furthermore, due to the diversification of applications, the strong variability of the electrical loads required and, above all, the high amperage, the distribution units known in the automotive sector are subject to structural limits: in fact, due to the high amperage there is risk that the conventional connection jumpers, internal to a single module or between different modules, heat up excessively and weaken especially in the curved portions up to reduce the contact pressure between the conductive strips and the contact elements. This can reduce the current flow between modules.

There is therefore a need to define an electrical power distribution unit that is free of the above-mentioned drawbacks.

### SUMMARY OF THE INVENTION

To substantially resolve the technical problems highlighted above, an aim of the present invention is to define an electrical power distribution unit which can use two or more basic electrical modules for any application and which is also modular and expandable. The basic electrical module is designed as a high voltage input/output interface (HV I/O). The basic electrical module may also include current sensors, power relays, fuse and other electrical components that assist the distribution of electrical power.

Advantageously, the number of basic electrical modules can be increased based on the needs of the specific application, thus being able to define a modular distribution unit.

In the case of even more demanding or specific applications, multiple electrical power distribution units can be stacked together.

The invention is applicable to different types of motor vehicles, particularly electric or hybrid ones. Advantageously, the invention finds application above all, but not only, in large motor vehicles (trucks, buses and similar).

Therefore, according to the present invention there is provided a modular power distribution unit having the characteristics set forth in the independent claim, annexed to the present description.

Further embodiments of the invention, preferred and/or particularly advantageous, are described according to the characteristics set forth in the attached dependent claims.

### BRIEF DESCRIPTION OF THE DRAWINGS

The invention will now be described with reference to the attached drawings, which illustrate some non-limiting embodiments, in which:

FIG. 1 is a perspective view of a basic electrical module, for an electrical power distribution unit, according to a preferred embodiment of the present invention,-FIG. 2 is a perspective view of the basic electrical module of FIG. 1, complete with further electrical components,

FIG. 3 is a perspective view of an electric power distribution unit, according to a preferred embodiment of the present invention,

FIG. 4 is a bottom perspective view of the electric power distribution unit of FIG. 3,

FIGS. 5 and 6 illustrate on an enlarged scale the details of the bus bars, positive and negative respectively,

FIG. 7 is a perspective view of the electric power distribution unit of FIG. 3 inserted in a containment casing,

FIG. 8 is a perspective view of the casing of FIG. 7, equipped with a cover,

FIG. 9 is a perspective view of a group of two electrical power distribution units, according to the present invention, in which the two units are stacked together, and

FIG. 10 illustrates, in a side view, the group of FIG. 9.

### DETAILED DESCRIPTION OF THE INVENTION

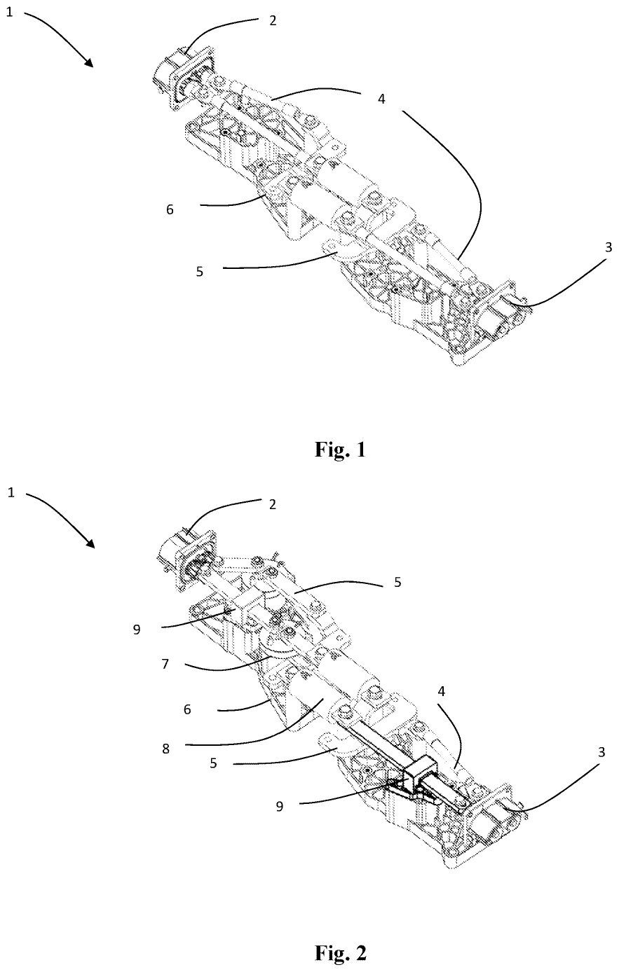

By way of purely illustrative and non-limiting example, the present modular electrical power distribution unit 10 comprising two or more basic electrical modules 1, will now be described with reference to the aforementioned figures. With particular reference to FIG. 1, a base electric module 1 includes at least one input port 2, at least one output port 3, a plurality of electrical cables 4 and a first plurality of electrical connection bus bars 5 and a base structure 6, in turn comprising a plurality of mechanical connection elements.

The input port 2 is an electrical connector and will be connected via appropriate wiring (of a known type and therefore not shown in the figure) to an electrical power source. In the automotive sector, to which the invention preferentially but not exclusively refers, sources of electric power could be, for example, a battery or battery pack, preferably high voltage, or a fuel cell. These devices are of a well-known type and are now widespread in the field of electric traction in motor vehicles.

The output port 3 is also an electrical connector and will be connected to appropriate electrical users. In the case of electric traction, these users may be one or more electric motors, one or more electric heaters, as well as further electrical accessories present in motor vehicles.

The electrical cables 4 and the bus bars 5 are high voltage electrical connection elements, both for the positive line and for the negative line. Their function is to establish an electrical connection between the input port 2 and the output port 3, as well as, as we will see below, between the ports and further electrical components which, depending on needs, can be assembled on the module basic electric.

In particular, the bus bars 5 are made of conductive material, for example aluminum, and are suitable for carrying currents even of high amperage under high voltage. They are elements with an almost linear development and include rectilinear portions and curvilinear portions in order to create a topological development that ensures all the necessary electrical connections.

The base structure 6 has a support function for the above-mentioned components and for the further electrical components. Advantageously, it can take on a basic reticular structure from which connection brackets can branch out. Even for the base structure 6 the topological development is such as to ensure all the necessary mechanical connections. Preferably, the base structure 6 can be made of plastic material and be obtained by molding. Alternatively and preferentially, the base structure can be obtained with “3D printing” techniques (or additive manufacturing).

With reference to FIG. 2, the base electric module 1, depending on the required application, may include further electrical components. In particular, it may alternatively or in combination include:
one or more 7 relays or electrical switches. As is known, the relay is a current diverter controlled by electromagnetic pulses: depending on the needs of the application, the relay will establish the appropriate electrical connections between sources and users. The relay can be located both on the positive line and on the negative line,
one or more fuses 8 on the positive line. The use of fuses is obviously appropriate to protect the remaining electrical components from high currents. As is known, the fuse is specially designed so that one or more of its elements can melt and open the electrical circuit when a certain current value is exceeded for a certain time,
one or more current sensors 9 and/or one or more voltage sensors (not indicated in the figure) to monitor the electrical quantities and provide data to the vehicle control units.

The base electric module, therefore, has characteristics of high standardization and flexibility: depending on the application, it may contain only the basic components or also additional electrical components. The standardization is due to the basic architecture of the electrical module. Flexibility is linked to the fact that it can easily integrate (or eliminate) further components. For example, if it were necessary to add a relay 7 to the basic electrical module, it will be sufficient to remove the appropriate bus bar 5, insert the relay and the appropriate bus bars 5 for connection to the circuit. On the contrary, if there is a need to eliminate a relay 7 from the base electric module, this can be done simply by replacing it with a busbar 5, without having to make further changes to the base electric module 1.

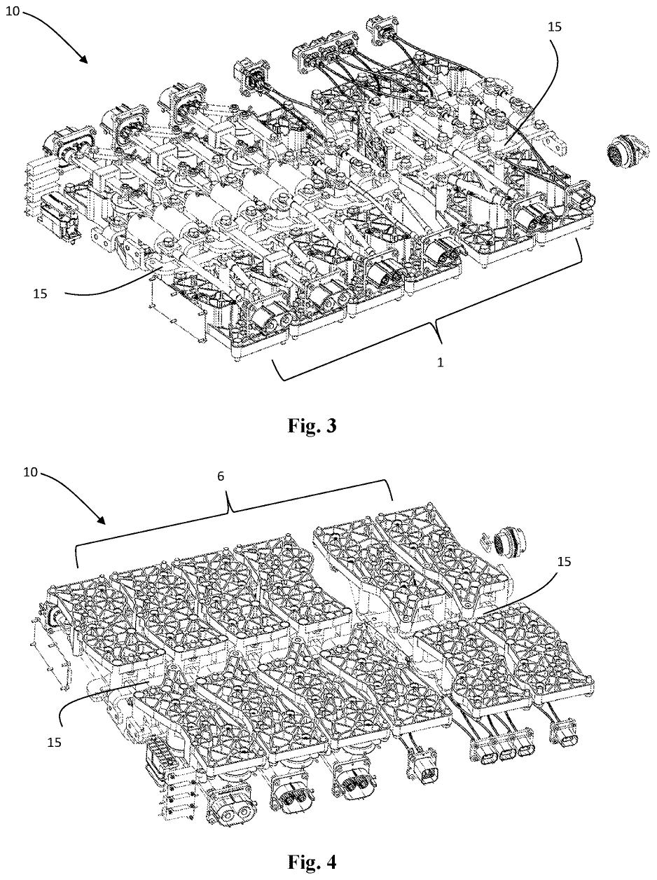

According to the present invention and with reference to FIGS. 3 to 8, the modular electrical power distribution unit according to the present invention is illustrated with reference 10. The modular power distribution unit 10 is obtained by assembling two or more electrical modules of base 1 (six in the example of FIGS. 3 and 4) and electrically connecting them to each other by means of a second plurality of intermodular bus bars 15, different from the first plurality of bus bars 5. These intermodular bus bars 15 as well as the bus bars 5 of the base electric module 1, are made of conductive material and are suitable for carrying high amperage currents under high voltage. They too have an almost linear development and include rectilinear portions and curvilinear portions. The top view of FIG. 3 illustrates the previously described components of each base electric module, while the bottom view of FIG. 4 highlights the base structures 6 of the individual base electric modules.

Advantageously, the number of base electric modules 1 is determined based on the needs of the specific application, thus being able to define modular distribution units that are very flexible even if created starting from standard elements. The number of base electric modules will be determined by the number of high voltage ports (input and/or output) that the specific application requires.

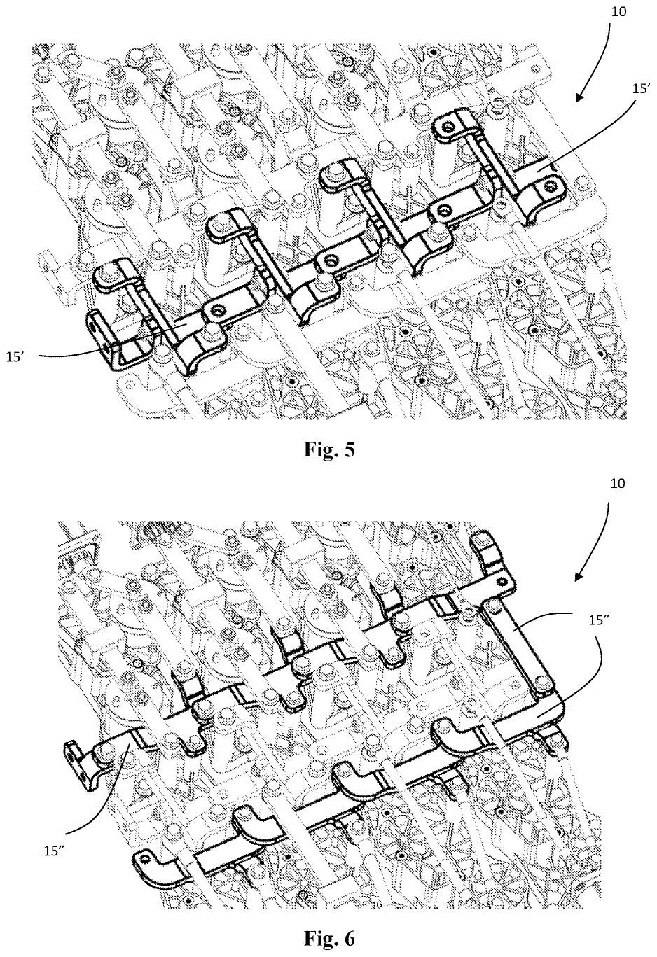

FIGS. 5 and 6 illustrate the connection between the different base electric modules 1 by means of 15′, 15″ intermodular bus bars for the positive line and the negative line respectively.

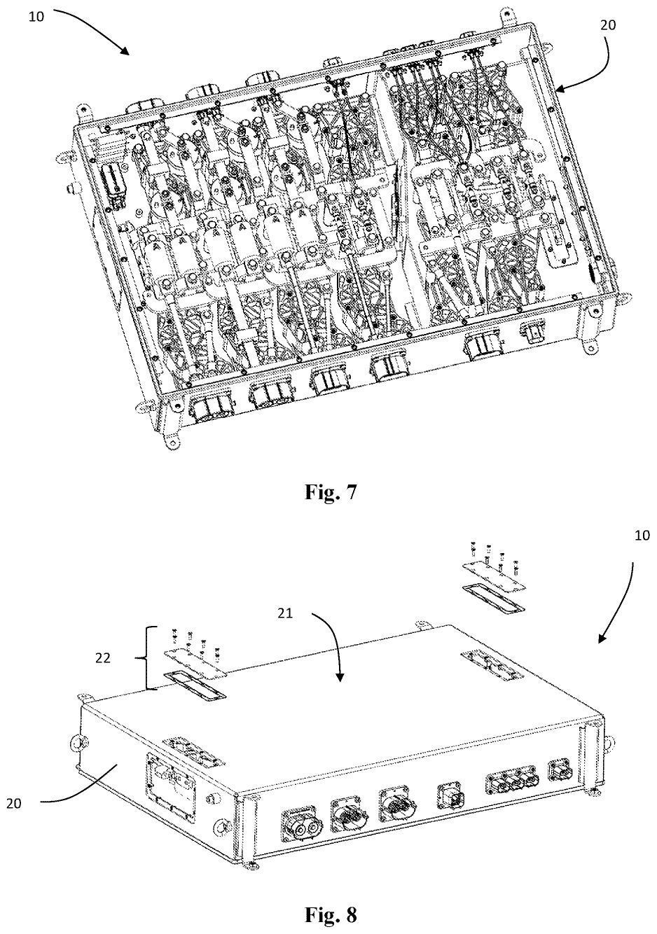

With reference to FIGS. 7 and 8, advantageously the modular distribution unit 10 can comprise and, therefore, be housed in a special housing 20, which can be provided with a cover 21. In particular, the cover 21 can also be provided of one or more service panels 22, which, as we will see below, can be dismantled and allow the connection of two modular distribution units 10 one above the other.

The modular electrical power distribution unit 10 will be able to work with high voltage values. Typical values may be 400 V or 700 V. For this purpose, the modular distribution unit 10 may be equipped with a high voltage interlock circuit. The high voltage interlock circuit is a safety feature of hybrid or all-electric vehicles to protect users from high voltage during the assembly, repair, maintenance and operation of a vehicle. The HVIL circuit acts as a kind of circuit breaker that sends a warning or error code to the driver if a high voltage connection becomes loose, disconnected, or damaged during vehicle operation.

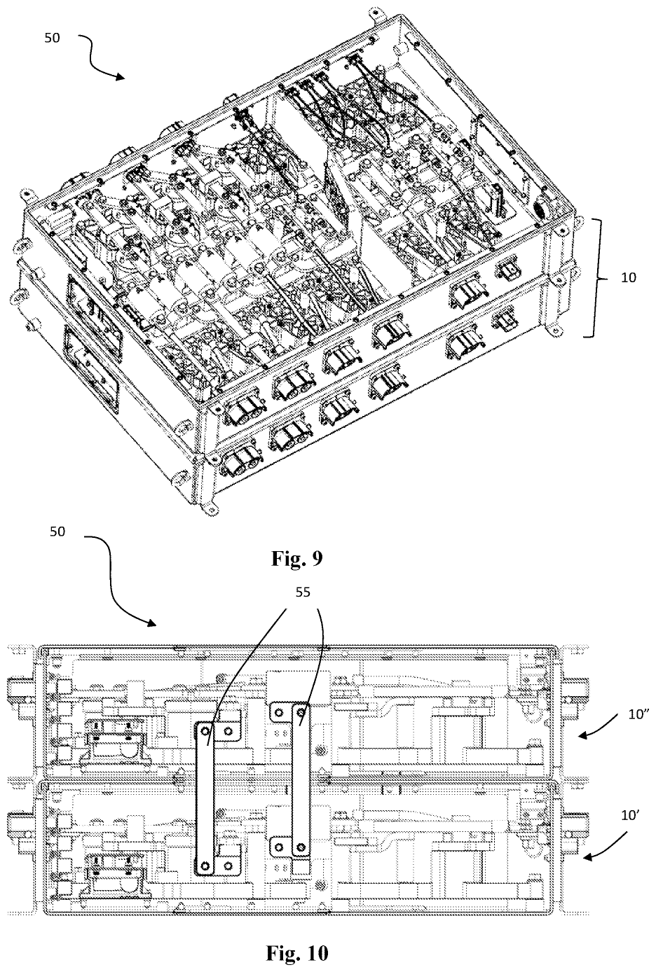

Advantageously, the modular distribution unit 10 will be able to simultaneously manage two voltage levels, for example 400 V and 700 V. With reference to FIGS. 9 and 10, the modular distribution unit 10 is expandable. Expandable means that two or more modular distribution units 10 could be mechanically and electrically connected to each other to increase the number of high voltage ports if necessary. In this way, a group 50 of modular distribution units 10 is created in which each modular distribution unit 10, following the first, is stacked on a modular distribution unit 10. The modular units are electrically connected by means of a third plurality of inter-unitary bus bars 55.

In particular, as in the examples in FIGS. 9 and 10, in the case of onerous or specific applications, two electrical power distribution units can be stacked together, doubling the number of input ports 2 and/or outlet ports 3. This operation is extremely simple, as there is no need to remove one of the two covers 21, but it will simply be necessary to remove the service panels 22 to make the electrical connections, as shown in FIG. 9. FIG. 10, finally, it is a side view illustrating a pair of inter-unitary bus bars 55, for the electrical connections between the two modular distribution units 10′, 10″.

As already mentioned, each single modular distribution unit 10 can simultaneously manage two voltage levels. Alternatively, the two modular distribution units 10 will be able to manage two different voltage levels, for example a first modular distribution unit 10′ will be able to manage the inputs and outputs at a voltage of 400 V, while a second modular distribution unit 10″ will be able to manage the inputs and outputs at a voltage of 700 V. In this way a reduction in the overall volume required will be achieved: a stacked solution of two modular distribution units to manage voltage levels of 400 V and 700 V will require a smaller volume compared to the solution with two modular distribution units separated from each other.

Evidently, for even more onerous and specific needs required by the application, the number of modular distribution units may be greater than two.

Ultimately, the modular electrical power distribution unit 10, according to the dictates of the present invention, has the following advantages:
extreme standardization and flexibility as it uses a base electric module with standard layout and basic components and with the possibility of being integrated by further electrical components,
high modularity, being able to integrate any number of base electric modules,
expandability, as it is possible to couple several modular distribution units together to form a group of modular distribution units, with a consequent reduction in the overall volume required by the group compared to the sum of the volumes of the individual modular distribution units,
possibility of managing multiple voltage levels.

In addition to the form of the invention as described above, it must be understood that there are numerous other variants. It must also be understood that these forms of embodiment are merely illustrative and do not limit either the scope of the invention, its applications or its possible configurations. On the contrary, although the above description allows the skilled person to implement the present invention at least according to one exemplary form of embodiment thereof, it should be understood that many variations of the described components are possible, without thereby departing from the scope of the invention as defined in the appended claims, which are interpreted literally and/or according to their legal equivalents.

1. A high voltage modular power distribution unit (10) for electric or hybrid vehicles, the modular power distribution unit being equipped with two or more base electric modules (1) mechanically connected to each other, the base electric module (1) comprising: at least one input port (2) connected to an electric power source, at least one output port (3) connected to an electric user, a plurality of electric cables (4) and a first plurality of electric connection bus bars (5), and a base structure (6), provided with a plurality of mechanical connection elements, the modular power distribution unit (10) being characterized by the fact that the two or more base electric modules (1) are electrically connected to each other by means of a second plurality of intermodular bus bars (15), which is different from the first plurality of electric connection bus bars (5).

2. The modular power distribution unit (10) according to claim 1, wherein the first plurality of bus bars (5) and the second plurality of intermodular bus bars (15) are made of conductive material, are configured for the transport of high amperage currents under high voltage, have an almost linear development and include rectilinear portions and curvilinear portions so as to achieve a topological development such as to ensure all the necessary electrical connections.

3. The modular power distribution unit (10) according to claim 1, wherein the base structure (6) has a base reticular structure from which connecting brackets depart.

4. The modular power distribution unit (10) according to claim 3, wherein the base structure (6) is made of plastic material and is obtained by molding or three-dimensional printing.

5. The modular power distribution unit (10) according to claim 1, wherein the base electric module (1) comprises, alternatively or in combination, one or more relays (7), one or more fuses (8), one or several current sensors (9), one or more voltage sensors.

6. The modular power distribution unit (10) according to claim 1, comprising a housing (20) provided with a cover (21).

7. The modular power distribution unit (10) according to claim 6, wherein the cover (21) is provided with one or more service panels (22).

8. The modular power distribution unit (10) according claim 1, comprising a high voltage interlock circuit.

9. A group (50) of modular power distribution units (10), wherein the single modular power distribution unit (10) is made according to claim 1, wherein each modular power distribution unit (10) subsequent to the first is stacked on a modular power distribution unit (10) preceding it and the modular power distribution units of the group (50) is electrically connected by means of a third plurality of inter-unitary bus bars (55).

10. The group (50) of modular power distribution units (10) according to claim 9, wherein the modular power distribution units (10) are two in number, are stacked together, are electrically connected by inter-unitary bus bars (55) and in which a first power modular distribution unit (10′) manages a first voltage level and a second modular power distribution unit (10″) manages a second voltage level, or both modular distribution units manage the first and second voltage levels.
